(19) United States
(12) Patent Application Publication
(10) Pub. No.: US 2006/0158806 A1
(43) Pub. Date: Jul. 20, 2006

(54) Single power source for serially connectable devices

(75) Inventor: Graeme Alan Robertson, Ferntree Gully (AU)

Correspondence Address: RYAN KROMHOLZ & MANION, S.C., POST OFFICE BOX 26618, MILWAUKEE, WI, 53226, US

(73) Assignee: Opdicom Pty Ltd

(21) Appl. No.: 11/049,504

(22) Filed: Feb. 2, 2005

(30) Foreign Application Priority Data
Jan. 19, 2005 (AU) 2005200225

(51) Int. Cl. H02H 3/00

(52) U.S. Cl. 361/62

(57) ABSTRACT

There is disclosed a serially connectable device (200) for acting as a master device to control power usage by itself and one or more other serially connectable devices comprising a power input port (208) through which power is supplied to the serially connectable device (200), an output serial power connector (206) for supplying power and power control signals to any other serially connectable device or devices connected via said first serial power connector to the supply of power received through said power input port (200), and a microcontroller (216) for controlling power usage by one or more internal components (218,222) of the serially connectable device and for producing control signals to control power usage by any other device or devices connected in series with said serially connectable device.

### FIELD OF THE INVENTION

The present invention relates to serially connectable peripheral devices. More particularly, the present invention relates to utilising a single power source for a plurality of such devices including stackable media storage devices.

### BACKGROUND OF THE INVENTION

Computer peripherals can be connected to computers by a number of different types of connections using a number of different protocols. Amongst such connections are connections that enable supply of power to the peripheral device such as USB ports and firewire ports.

We have developed a stackable media device, that is constructed so that a tower of stackable storage devices can be used to store a large quantity of CD-ROMS or other optical media and the entire tower can be serially connected to the same USB port. There is a need to control power usage by the devices in such a stack or of other serially connected devices. A primary purpose of the present invention is to solve these needs and provide further, related advantages.

### SUMMARY OF THE INVENTION

In a first broad aspect, the invention provides a serially connectable device for acting as a master device to control power usage by itself and one or more other serially connectable devices comprising:

a power input port through which power is supplied to the serially connectable device;

an output serial power connector for supplying power and power control signals to any other serially connectable device or devices connected via said first serial power connector to the supply of power received through said power input port;

a microcontroller for controlling power usage by one or more internal components of the serially connectable device and for producing control signals to control power usage by any other device or devices connected in series with said serially connectable device.

In a second broad aspect, the invention provides a system for providing a single power source for a plurality of serially connectable devices comprising:

a computer;

a first serially connectable device coupled to said computer via a power input port, said first serially connectable device having a output serial power connector; and

a second serially connectable device having an input serial power connector, said serially connectable device serially connected to said first serially connectable device, said input serial power connector of said second serially connectable device connected to said output serial power connector of said first serially connectable device,

wherein said first serially connectable device provides power to said second serially connectable device via said output serial power connector of said first serially connectable device and said input serial power connector of said input serially connectable device, and

wherein said first serially connectable device controls the power consumed by said first serially connectable device and said second serially connectable device at all times via power switching circuitry.

In a third broad aspect, the invention provides a method for providing a single power source for one or more serially connectable devices, the serially connectable devices being electrically connected to each other via serial power connectors comprising:

connecting the single power source to a single serially connectable device, said single serially connectable device transmitting power to the remaining serially connectable devices via the serial power connectors;

switching power so that only one serially connectable device operates certain elements of the device at any time.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram schematically illustrating a system for storing storage medium in one or more stackable storage device in accordance with one embodiment of the invention;

FIG. 2 is a block diagram schematically illustrating a power management system within one stackable storage device in accordance with one embodiment of the invention;

FIG. 3 is an electrical diagram schematically illustrating an electrical circuit for a single USB bus power source in accordance with one embodiment of the invention;

FIG. 4 is a flow diagram schematically illustrating a powering up sequence for a connected stack of storage devices in accordance with one embodiment of the invention;

FIG. 5 is a diagram schematically illustrating a method for controlling motor power in accordance with one embodiment of the invention.

FIG. 6 illustrates a method for controlling power;

FIG. 7 is a flow chart illustrating an alternative technique for monitoring low voltage;

FIG. 8 is a flow chart illustrating an alternative technique for monitoring current; and

FIG. 9 is a diagram schematically illustrating an alternate method to that of FIG. 5; and

FIG. 10 is a perspective view of a stack of three disc storage devices.

### DETAILED DESCRIPTION

Embodiments of the present invention are described herein in the context of a tower of stacked media storage devices. Those of ordinary skill in the art will realize that the following detailed description of the present invention is illustrative only and is not intended to be in any way limiting. Other embodiments of the present invention will readily suggest themselves to such skilled persons having the benefit of this disclosure. In particular, persons skilled in the art will appreciate that the invention can be applied to other serially connectable devices. Reference will now be made in detail to implementations of the present invention as illustrated in the accompanying drawings. The same reference indicators will be used throughout the drawings and the following detailed description to refer to the same or like parts.

Herein, the term “power input port” is used to refer to an input port of a serially connectable device via which the serially connectable device can be supplied with power and control signals, typically from an output port of a computer. Examples of such ports are USB ports and Firewire ports.

The terms “input” and “output” are used to explain the power direction, however communication will be bi-directional.

Here the term “serially connectable device” refers to a device adapted to be connected with other devices to form a series of connected devices. Such series being referred to as a series of two or more devices. That is, there may be a minimum of two devices. The maximum number of devices will depend on a variety of parameters, and in the preferred embodiment is five devices. While the series of devices will typically be connected to a serial port, the term “serially connectable” is not intended to imply that the devices must be connected to a serial port.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by software running on such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Mac OSX available from Apple of Cupertino, Microsoft® Windows® XP and Windows® 2000, Windows ME, Windows 98 SE, all available from Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet.

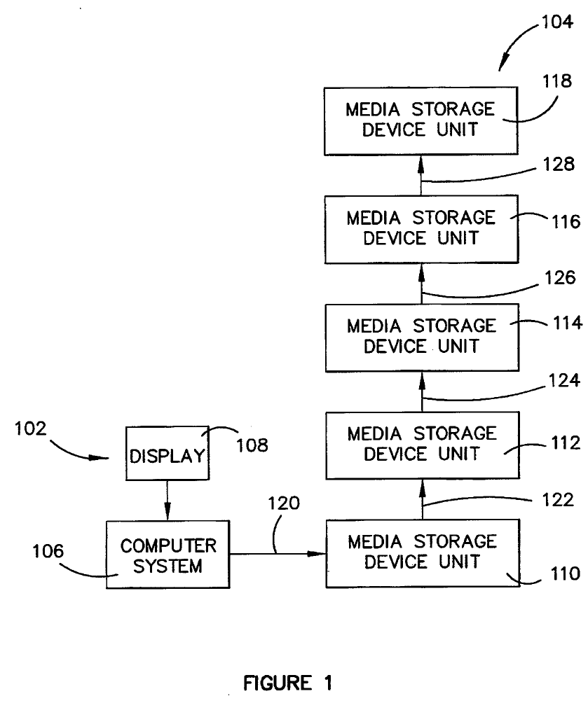

FIG. 1 is a block diagram schematically illustrating a system 102 for storing storage medium, such as optical medium like CDs and DVDs, in a tower 104 of one or more stacked storage devices. The stacked media storage devices 110, 112, 114, 116, and 118 are stacked upon one another as illustrated in FIG. 1 with the storage device 110 as the bottom storage unit. A computer system 106 comprising at least one USB connection (not shown) is attached to a display 108 such as a monitor. The bottom unit 110 is the only storage device from the storage tower (made up of units 110, 112, 114, 116, 118) that is connected to the computer system 106 via a USB cable 120. FIG. 1 illustrates a system having five storage device units 110, 112, 114, 116, 118 stacked on top of one another with unit 110 at the bottom. It will thus be appreciated that the units 110, 112, 114, 116, 118 are serially connected to the USB port of computer system 106.

Those of ordinary skills in the art will recognize that the computer system 106 consists of at least one microcontroller (not shown), memory (not shown), a power source (not shown), and a motherboard (not shown) connected to a USB connection. The computer system will typically be a personal computer.

Each media storage device can physically store one or more optical storage medium such as CDs and DVDs. For example, each storage device may include a carousel (not shown) having slots to accommodate the CDs and DVDs.

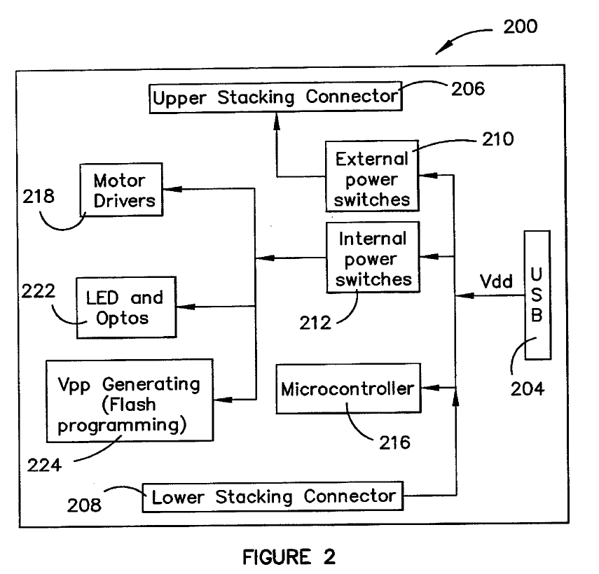

The carousel may be powered by a motor driver and controlled by a microcontroller. A slit opening in the storage device allows a CD or DVD to be inserted and removed. The hardware inside a storage device unit is illustrated and described in more detail in FIG. 2. Each stacked storage devices 110, 112, 114, 116, 118 may be connected to one another in a serial manner through their respective connections 122, 124, 126, and 128. Thus, the tower 104 of stacked storage devices 110, 112, 114, 116, and 118 may be powered through the single USB connector 120 connecting bottom storage device 110 to computer system 106.

FIG. 10 is an exploded perspective view of a stack of such storage devices 1000. Each storage device 1000a,1000b,1000n has an upper stacking connector 1004a, 1004b, 1004n having five electrical contacts and a lower stacking connector 1006a, 1006b having five pins. Each storage device 1000 has a slot 1002a,1002b,1002n for receiving a disc into carousel (not illustrated). The carousel can receive up to one hundred discs. Each storage device 1000 also has a USB port (not shown).

FIG. 2 is a block diagram schematically illustrating the hardware structure 200 for managing power within each stackable storage device as illustrated in FIG. 1 and FIG. 10. Each storage device includes a USB port 204 for receiving a USB connector as illustrated in FIG. 1. The USB port 204 includes communication and power pins (not shown). The USB port 204 is electrically connected to external power switches 210, internal power switches 212, lower stacking connector 208, and microcontroller 216.

The external power switches 210 switches power to the upper unit via upper stacking connector (USC) 206—i.e. the USC acts as a serial output power port and the external power switch controls whether power is supplied to the output port. The upper stacking connector 206 is electrically connected to the lower stacking connector (LSC) 208 of another unit stacked on top of the present unit. The upper stacking connector 206 has five conductive pins. In the upper units the power comes from the USC 206 of the next lower unit, into the LSC 208 and to the switches. It is only the master, or bottom unit, where the power comes from the USB port 204.

The internal power switches 212 switches power to the present unit from either the LSC or the USB depending on the source of the unit's power. In particular, the internal power switches 212 provides power to motor drivers 218, LED and Opto sensor 222, and Vpp Generation 224. The motor drivers 218 power the carousel motor (not shown) of the present unit. The carousel motor mechanically turns the carousel under the unit's control. The LED provides visual notification to a user whether the storage device unit is powered, and what its current status is. (Busy, idle, errored etc.) The opto sensor 222 senses any addition or removal of an optical disc (e.g. CD or DVD) to the present storage device. The Vpp Generation 224 provides a higher voltage (12V) for the programming of the flash memory in the microcontroller. (Normal operation of the microcontroller and its memory is with a 5V supply. To program or reprogram the internal flash memory the higher voltage is required. This is typically done when the user downloads a firmware upgrade from the internet and selects to program it into a unit.

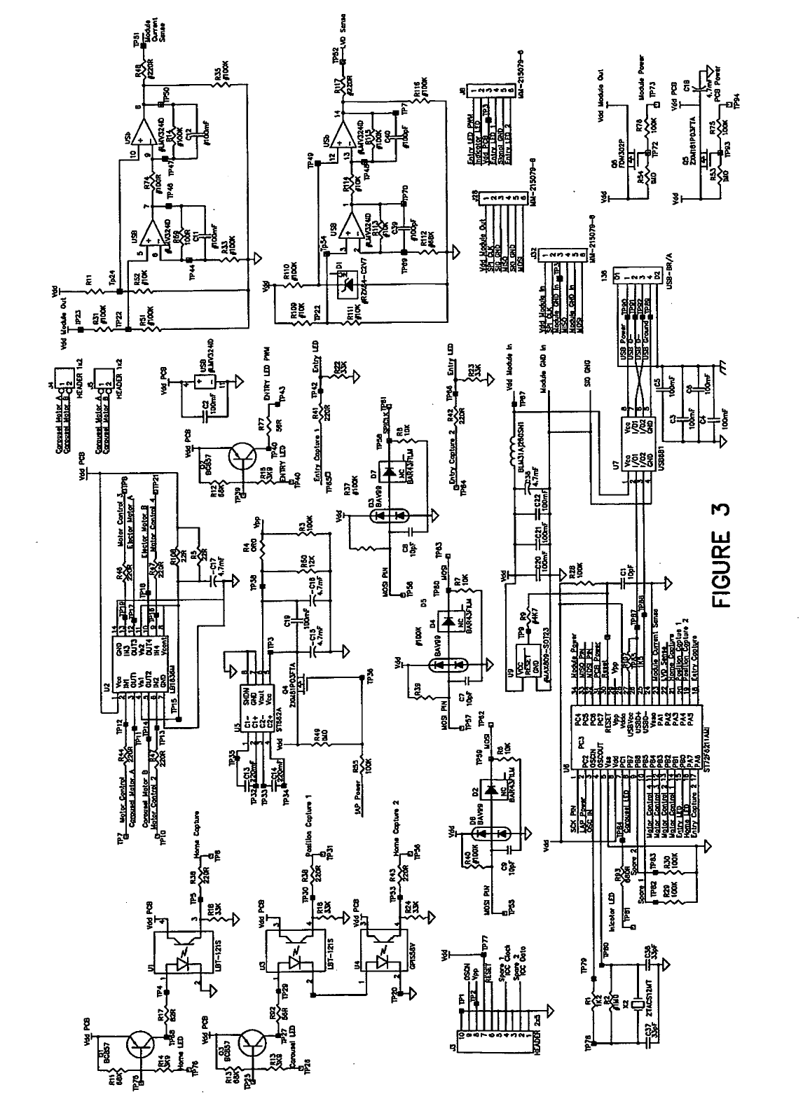

The microcontroller 216 is either powered via the USB port 204 (in the case of the a storage device being a master device, in this embodiment the bottom one) or via a lower stacking connector 208 (in the case of a storage device being a slave device, in this embodiment stacked on top of another storage device). That is, the master device is the first device in the series and the only device to receive power directly from the USB port, all subsequent devices in the series of connected devices are slave devices. The microcontroller of the master device includes a power control algorithm (described in more detail below) that controls the power usage of the entire tower of storage devices for any particular configuration or state of the individual storage device unit, or tower of storage device units. The power control algorithm works across the entire tower. Within the entire tower, the algorithm allows only a single motor to operate at any time and also minimizes concurrent opto sensor operation. That is, the master unit controls power usage by its own internal components and sends power control signals to the other units in the stack. These power control signals are interpreted by the microcontrollers of the other units and they control their internal components accordingly. The opto sensors of each unit are controlled to operate out of phase with one another so that the opto sensors of only one unit operate at any one time. An example of a electric circuit embodying the power control algorithm is illustrated in FIG. 3.

In the case where a storage device unit is not powered via USB connector 204, the lower stacking connector 208 provides power to the storage device unit (external power switches 210, internal power switches 212, microcontroller 216). The lower stacking connector 208 is electrically connected to the upper stacking connector of another storage device unit stacked below the present storage device unit. The lower stacking connector 208 has a set of conductive pins.

FIG. 3 is an electrical diagram schematically illustrating an example of an electrical circuit for a single USB bus power source. The USB port is shown as J36. Power pins are designated pin 1 and pin 4 on this connector. From this entry point, power is distributed into three switched busses: Vdd, Vdd Module Out, and Vdd PCB. The switching of buses Vdd PCB and Module Out is accomplished by devices Q5 and Q6 respectively under the control of the microcontroller U6. The distribution of power is as follows: (1) non-switched power supply for essential circuitry in the present storage device unit, (2) switched power supply for internal components of the storage device unit, and (3) switched power supply to the upper storage device unit.

Electrical connection of the stacked storage device units are via the Upper Stacking Connector (USC) 206. The USC has five contact pins that mate with five pins on the Lower Stacking Connector (LSC) 208 of the storage device unit above the present storage device unit. Two pins provide power and three pins provide communications. The USC 206 is connected via cabling to J28 and LSC 208 may be connected to J32 on the main PCB.

The master storage device unit (in this embodiment the bottom storage device unit), is connected differently to other storage device units in the tower only in that it has a USB connection to the host computer. All other units receive switched power from the adjacent lower storage device unit via the LSC and provide switched power to the adjacent upper storage device unit through the USC.

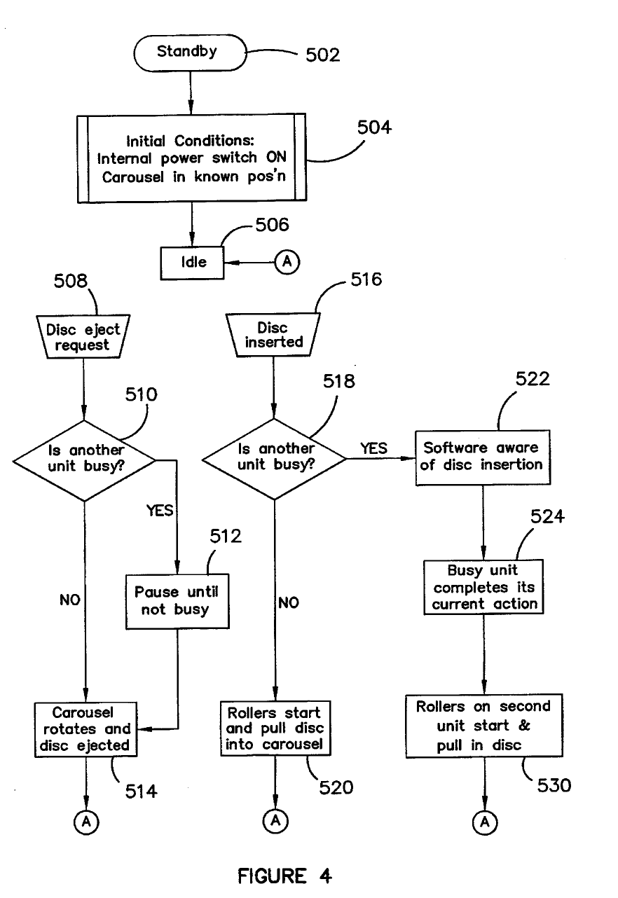

FIG. 4 is a diagram schematically illustrating a method for controlling motor power from a connected stack of storage device units. At a standby 502, the storage device unit is powered on and idle. At 504, the initial conditions include the internal power switched on, and the carousel being at a known position. The state 506 represents an idle status.

At 508, an ejection of a disc stored in the storage device is requested. The microcontroller checks whether another unit is busy at 510. At 512, the storage device unit is paused until no other units are busy. If no other storage device units are busy, the carousel rotates and the requested disc is ejected at 514.

At 516, a disc is inserted in the storage device. The microcontroller checks whether another unit is busy at 518. If no other storage device units are busy (i.e. carousel or roller motors are not in operation), rollers within the storage device unit start and pull the disc into the carousel at 520. If another unit is busy the insertion of the disk is noted at step 522 by optical sensors. No action is taken on the newly inserted disc which is held in place by the friction of the rollers until the busy unit completes its action at 524. At 530 the rollers are stated and pull the disc into the storage unit.

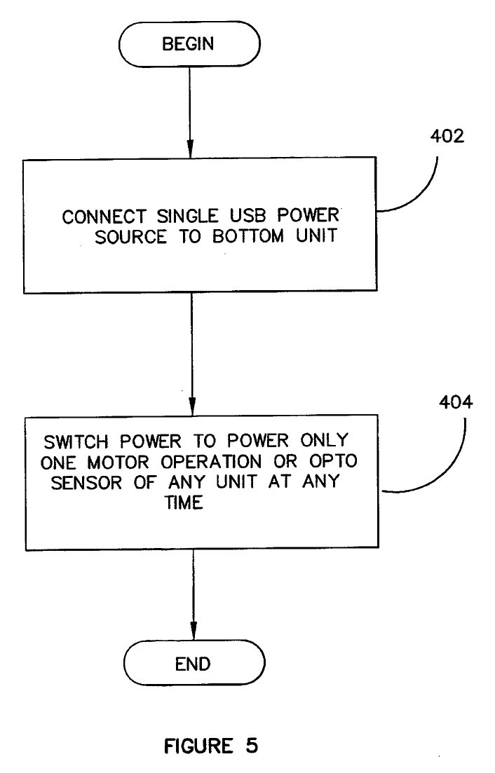

FIG. 5 illustrates a method for controlling power supplied to a tower of stacked storage devices via a single USB connection. At 602, the single USB power source is connected to the bottom unit of the tower. At 604, the power is switched to power only one motor or opto sensor of any one storage device unit in the tower at any time.

FIG. 6 is a flow diagram schematically illustrating an alternative method for monitoring USB bus voltage using a separate low voltage detection (LVD) circuit. At step 702 the LVD 702 monitors the USB bus voltage. Should the USB bus voltage drop below limits, the internal 212 and external 210 power switches are turned off at 704. A warning and halt dialogue may be displayed at 706.

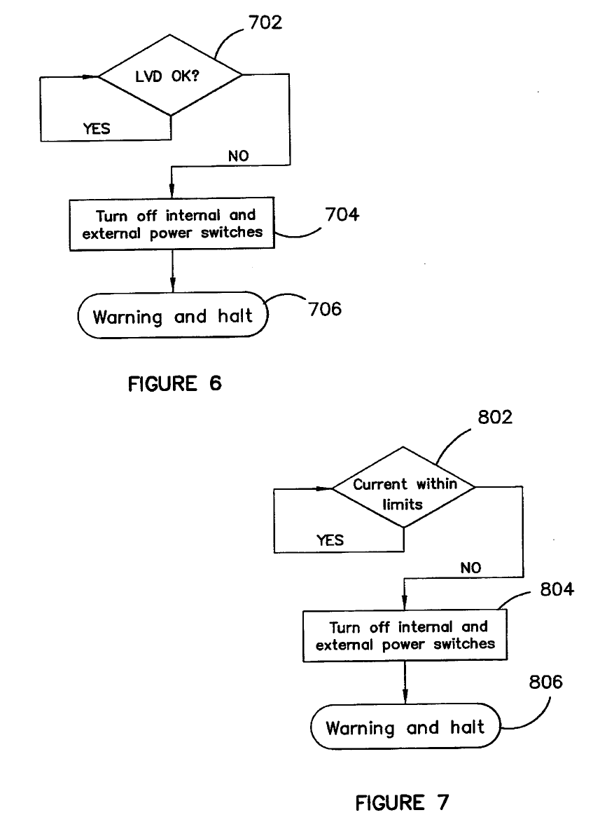

FIG. 7 illustrates an alternative method for monitoring current once the external power switch 210 is on using a current sensor. At 802, the current is monitored. Should the current exceed limits, the internal 212 and external 210 power switches are turned off at 804. At 806, a warning and halt dialogue may be displayed.

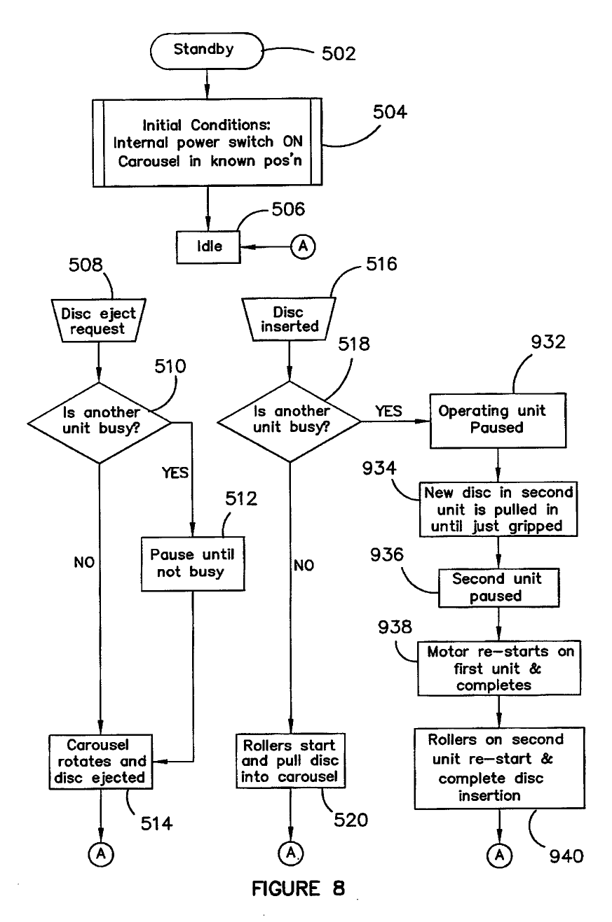

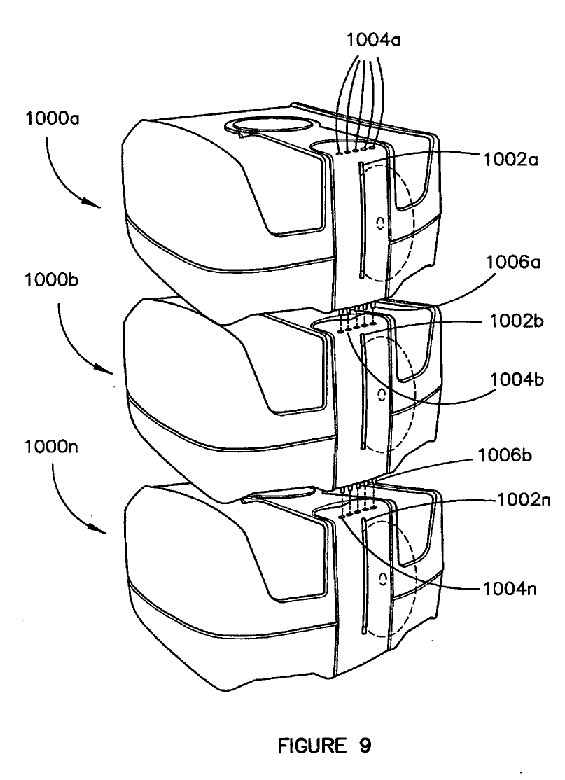

FIG. 8 is a diagram schematically illustrating a method for controlling motor power from a connected stack of storage device units of an alternative embodiment. Where the same numbering is used as FIG. 5, the same method steps apply.

In this embodiment should any other unit be found busy at 518, the operating unit is paused at 932. No motors from that operating unit will be operated. At 934, a new disc in the second unit is pulled in until it is just gripped. That is, the second unit roller motor operates for a brief period while the first unit is paused. At 936, the second unit is paused with no motors operating. At 938, the motor from the first unit restarts and completes its task and then is turned off. At 940, the rollers on the second unit restart and complete the disc insertion process. The second unit motors operate until the disc is inserted.

In the above embodiment, each serially connectable stackable media storage device is of identical construction. While this has advantages—e.g. that each device is capable of acting as a master device or a slave device depending on its place in the series of devices and all devices can be manufactured to the same specification—persons skilled in the art will appreciate that devices could be designed to operate specifically as master or slave units. In such an embodiment, the master units would not need a lower stacking connector. Such an embodiment would also allow the slave units to be of simpler construction, for example they would not need a USB connection and could be provided with a simpler micro controller.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A serially connectable device for acting as a master device to control power usage by itself and one or more other serially connectable devices comprising:
a power input port through which power is supplied to the serially connectable device;
an output serial power connector for supplying power and power control signals to any other serially connectable device or devices connected via said first serial power connector to the supply of power received through said power input port; and
a microcontroller for controlling power usage by one or more internal components of the serially connectable device and for producing control signals to control power usage by any other device or devices connected in series with said serially connectable device.

2. A serially connectable device as claimed in claim 1, further comprising an input serial power connector for supplying power to the serially connectable device when the serially connectable device is connected to an output serial power connector of a second serially connectable device, whereby said serially connectable device is also able to act as a slave device and wherein said microcontroller is responsive to power signals from the second serially connectable device to control power usage by one or more internal components of said second serially connectable device.

3. A serially connectable device as claimed in claim 2, which is stackable and wherein the output and input serial power connectors are upper and lower stacking connectors respectively.

4. A serially connectable device as claimed in claimed in claim 3, wherein said upper stacking connector is coupled to a lower stacking connector of a second serially connectable device stacked on top of the stackable serially connectable device, the stackable device providing power to said second serially connectable device.

5. A serially connectable device as claimed in claim 3, wherein said lower stacking connector is coupled to an upper stacking connector of a second serially connectable device stacked below the serially connectable device, said serially connectable device providing power to the serially connectable device.

6. A serially connectable device as claimed in claim 1 that constitutes a stackable media storage device.

7. A serially connectable media storage device as claimed in claim 6, wherein said at least one internal component is selected from the group of:
a carousel coupled to a motor driver;
at least one LED; and
at least an optical sensor.

8. A serially connectable device as claimed in claim 1, wherein each serial power connector comprises five contact pins, two of which provide power, and at least two of which provide communication including communication of power control signals.

9. A serially connectable device as claimed in claim 1, wherein said microcontroller allows only one single motor operation of a single serially connectable device to be powered at any time.

10. A system for providing a single power source for a plurality of serially connectable devices comprising:
a computer;
a first serially connectable device coupled to said computer via a power input port, said first serially connectable device having an output serial power connector; and
a second serially connectable device having an input serial power connector, said serially connectable device serially connected to said first serially connectable device, said input serial power connector of said second serially connectable device connected to said output serial power connector of said first serially connectable device,
wherein said first serially connectable device provides power to said second serially connectable device via said output serial power connector of said first serially connectable device and said input serial power connector of said input serially connectable device, and
wherein said first serially connectable device controls the power consumed by said first serially connectable device and said second serially connectable device at all times via a power switching circuitry.

11. A system as claimed in claim 10, wherein the second serially connectable device has an output serial power connector.

12. A system as claimed in claim 11, wherein the first and second serially connectable devices are stackable.

13. A system as claimed in claim 10, wherein the output and input serial power connectors comprise upper and lower serial power connectors respectively.

14. The system of claim 10 wherein said power switching circuitry includes:
a microcontroller in said first serially connectable device, said microcontroller controlling power supplied to at least one internal component of said first device and for producing power control signals for controlling power usage by said second serially connectable device.

15. The system of claim 14 wherein the second serially connectable device has a micro processor responsive to said power control signals to control power usage by internal components of said second serially connectable device.

16. A system as claimed in claim 14, comprising at least a third serially connectable device and wherein the micro processor produces power control signals to control power usage by said at least a third serially controllable device.

17. A system as claimed in claim 10, wherein the serially connectable devices constitute media storage devices.

18. A system as claimed in claim 17, wherein each media storage device has one or more optical sensors and the micro controller of the first serially connectable device controls operation of the devices such that the optical sensors of only one device are operational at any one time.

19. A system as claimed in claim 17, wherein each serially connectable media storage device has one or more internal components selected from the group of:
a carousel coupled to a motor driver;
at least one LED; and
at least one optical sensor.

20. A system as claimed in claim 10 wherein each serially connectable device has a motor and the micro processor of the first serially connectable device controls the serially connectable devices such that only one motor is operational at any one time.

21. A method for providing a single power source for one or more serially connectable devices, the serially connectable devices being electrically connected to each other via serial power connectors comprising:
connecting the single power source to a single serially connectable device, said single serially connectable device transmitting power to the remaining serially connectable devices via the serial power connectors;
switching power so that only one serially connectable device operates at any time.

22. A method as claimed in claim 21, wherein power is switched so that only one single motor of one serially connectable device operates at any time.

23. A method as claimed in claim 21, wherein power is switched so that only optical sensors of one serially connectable device operates at any time.
